(19) United States
(12) Patent Application Publication
(10) Pub. No.: US 2008/0043165 A1
(43) Pub. Date: Feb. 21, 2008

(54) DISPLAY PANEL

(75) Inventor: Dong-Gyu KIM, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/769,833

(22) Filed: Jun. 28, 2007

(30) Foreign Application Priority Data
Jun. 30, 2006 (KR) 1020060060421

(51) Int. Cl. G02F 1/136

(52) U.S. Cl. 349/46

(57) ABSTRACT

A display panel includes a first substrate, a second substrate and a liquid crystal layer. The first substrate includes a signal wiring, a thin film transistor electrically connected to the signal wiring and a pixel electrode electrically connected to the thin film transistor and disposed in a unit pixel. The second substrate includes a light-blocking layer blocking light, a common electrode including a domain defining member formed on the light-blocking layer and corresponding to the pixel electrode. The liquid crystal layer is disposed between the first substrate and the second substrate. The light-blocking layer includes a main light-blocking part disposed at edges of the unit pixel and covering the signal wiring, and a sub light-blocking part extended from the main light-blocking part to an area in which the domain defining member is not formed.

This application claims priority to Korean Patent Application No. 2006-60421 filed on Jun. 30, 2006, and all the benefits accruing therefrom under 35 U.S.C. §119, the contents of which are herein incorporated by reference in its entirety.

### BACKGROUND OF THE INVENTION

1. Field of the Invention

The present invention relates to a display panel. More particularly, the present invention relates to a display panel capable of improving image display quality.

2. Description of the Related Art

In general, a liquid crystal display (“LCD”) apparatus includes an LCD panel and a backlight assembly. The LCD panel displays images using light-transmittance rate of liquid crystals, and the backlight assembly is disposed under the LCD panel to provide the LCD panel with light.

The LCD panel includes a first substrate, a second substrate facing the first substrate and a liquid crystal layer disposed between the first substrate and the second substrate. The first substrate includes a signal wiring, a thin film transistor electrically connected to the signal wiring and a pixel electrode electrically connected to the thin film transistor. The second substrate includes a light-blocking layer, a color filter covering the light-blocking layer and a common electrode formed on the color filter.

When transporting or using the LCD panel after manufacturing the LCD panel, the LCD panel may be damaged by an externally provided impact, so that the first and second substrates may be misaligned by the impact. The second substrate is shifted to the left or right with respect to the first substrate by the impact.

When the second substrate moves with respect to the first substrate, the light-blocking layer of the second substrate is misaligned with respect to the first substrate. When the light-blocking layer of the second substrate is misaligned with respect to the first substrate, light is transmitted in an area of the second substrate designed not to transmit the light. Therefore, the LCD panel display does not display a perfect black image by the light leaking, and image display quality is deteriorated.

### BRIEF SUMMARY OF THE INVENTION

An exemplary embodiment provides a display panel which prevents light leaking by misalignment of first and second substrates and improves image display quality.

In an exemplary embodiment, a display panel includes a first substrate, a second substrate and a liquid crystal layer.

The first substrate includes a gate wiring formed in a first direction, a data wiring formed in a second direction substantially perpendicular to the first direction, a thin film transistor electrically connected to the gate wiring and the data wiring, and a pixel electrode electrically connected to the thin film transistor and disposed in a unit pixel.

The second substrate includes a light-blocking layer blocking light, a common electrode disposed on the light-blocking layer, corresponding to the pixel electrode and having a domain defining member dividing the unit pixel into a plurality of domains.

The liquid crystal layer is disposed between the first substrate and the second substrate.

The light-blocking layer includes a main light-blocking part disposed at edges of the unit pixel and covering the gate wiring and the data wiring, and a sub light-blocking part extended from the main light-blocking part. The sub light-blocking part is protruded toward an area in which the domain defining member paralleling to the data wiring is not disposed.

In an exemplary embodiment, the domain defining member includes a body inclined with respect to the first direction and a branch connecting an end portion of the body and extended in the second direction. The sub light-blocking part of the light blocking layer is protruded to an area in which the branch of the common electrode is not disposed.

In an exemplary embodiment, a display panel includes a first substrate, a second substrate and a liquid crystal layer.

The first substrate includes a gate wiring formed in a first direction, a data wiring formed in a second direction which is substantially perpendicular to the first direction, a thin film transistor electrically connected to the gate wiring and the data wiring, a pixel electrode electrically connected to the thin film transistor and disposed in a unit pixel, and a storage wiring partially overlapped with the pixel electrode and a portion of the data wiring.

The second substrate includes a light-blocking layer blocking light, a common electrode disposed on the light-blocking layer, corresponding to the pixel electrode and including a domain defining member dividing the unit pixel into a plurality of domains and being adjacent to the storage wiring.

The liquid crystal layer is disposed between the first substrate and the second substrate.

The storage wiring is overlapped with a portion of the data wiring corresponding to an area in which the domain defining member of the common electrode is not disposed.

In an exemplary embodiment, the storage wiring includes a main storage part extended in the first direction, a first sub storage part extended from the main storage part in the second direction and overlapped with a first end portion of the pixel electrode, a second sub storage part extended from the main storage part in the second direction and overlapped with a second end portion to the first end portion of the pixel electrode, and a light-blocking storage part extended from one of the first and second sub storage parts toward the data wiring and overlapped with a portion of the data wiring.

In an exemplary embodiment, the sub light-blocking part is protruded from the main light-blocking part to an area except where the domain defining member of the common electrode is disposed, or is overlapped with a part of the data wiring corresponding to an area except where the domain defining member of the common electrode is disposed, so that light leaking caused by misalignment of the first and second substrates is reduced or effectively prevented and image display quality improves.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating an exemplary embodiment of a unit pixel of a display panel in accordance with the present invention;

FIG. 2 is a plan view illustrating an exemplary embodiment of a storage wiring, a gate wiring and a gate electrode of the unit pixel of FIG. 1;

FIG. 3 is a plan view illustrating an exemplary embodiment of a data wiring, a source electrode, a drain electrode, a connecting electrode and an active layer of the unit pixel of FIG. 1;

FIG. 4 is a plan view illustrating an exemplary embodiment of a pixel electrode of the unit pixel of FIG. 1;

FIG. 5 is a plan view illustrating an exemplary embodiment of a common electrode of the unit pixel of FIG. 1;

FIG. 6 is a plan view illustrating an exemplary embodiment of a light-blocking layer of the unit pixel of FIG. 1;

FIG. 7 is a cross-sectional view taken along line I-I′ of FIG. 1;

FIG. 8 is a cross-sectional view taken along line II-II′ of FIG. 1;

FIG. 9 is a cross-sectional view taken along line III-III′ of FIG. 1;

FIG. 10 is a cross-sectional view illustrating an exemplary embodiment of a misalignment of the first and second substrates of FIG. 9 omitting the sub light-blocking layer;

FIG. 11 is a cross-sectional view illustrating an exemplary embodiment of a misalignment of the first and second substrates of FIG. 9;

FIG. 12 is a plan view illustrating another exemplary embodiment of a light-blocking layer of a unit pixel of a display panel in accordance with the present invention;

FIG. 13 is a plan view illustrating another exemplary embodiment of a light-blocking layer of a unit pixel of a display panel in accordance with the present invention;

FIG. 14 is a plan view illustrating another exemplary embodiment of a unit pixel of a display panel in accordance with the present invention;

FIG. 15 is a plan view illustrating an exemplary embodiment of a light-blocking layer in the unit pixel of FIG. 14;

FIG. 16 is a plan view illustrating an exemplary embodiment of a storage wiring of the unit pixel of FIG. 14;

FIG. 17 is a cross-sectional view taken along line IV-IV′ of FIG. 14;

FIG. 18 is a cross-sectional view taken along line V-V′ of FIG. 14; and

FIG. 19 is a cross-sectional view illustrating an exemplary embodiment of a portion of a unit pixel of a display panel in accordance with the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” other elements or features would then be oriented “upper” the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

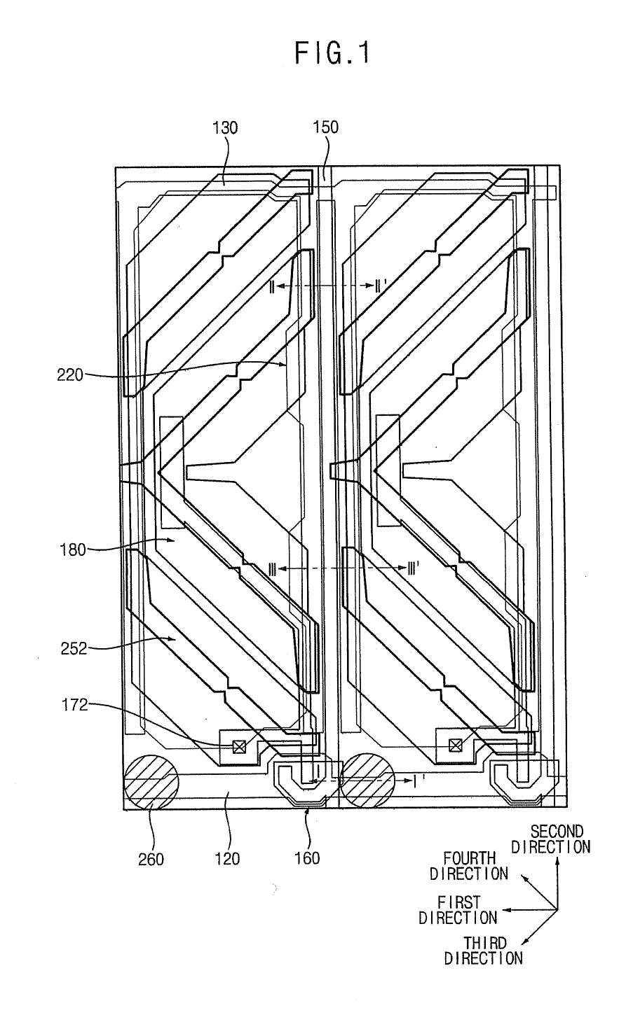

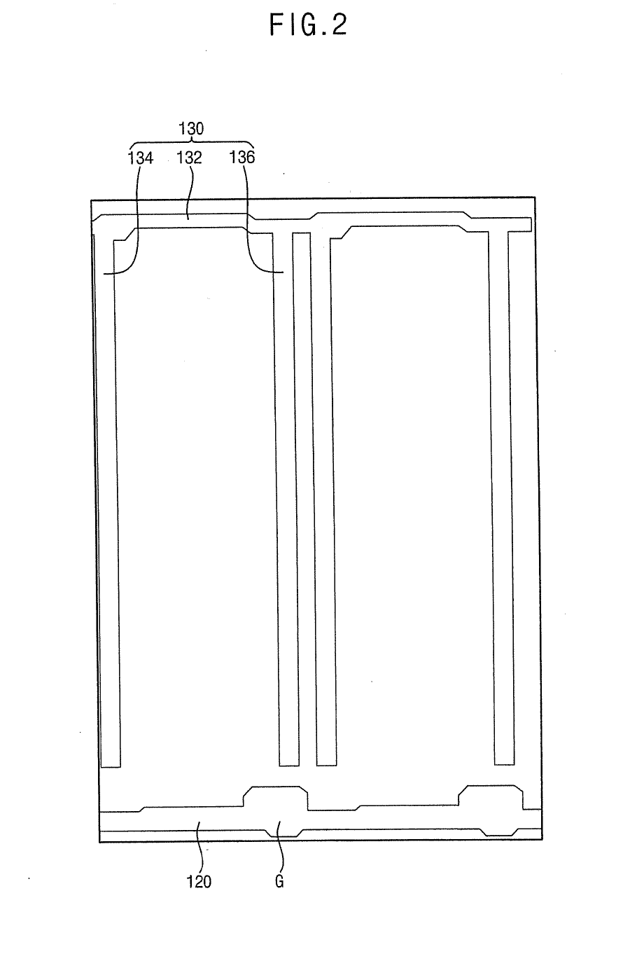

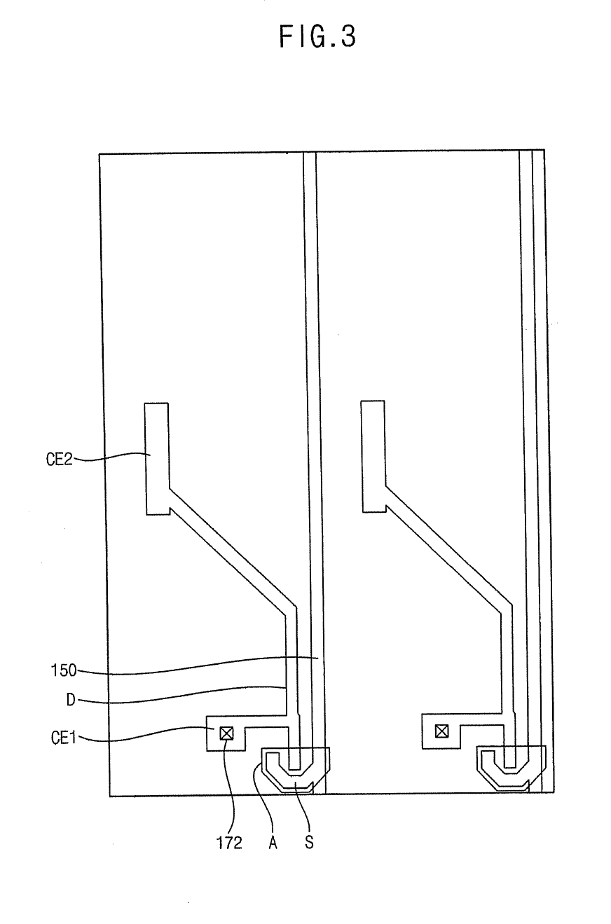

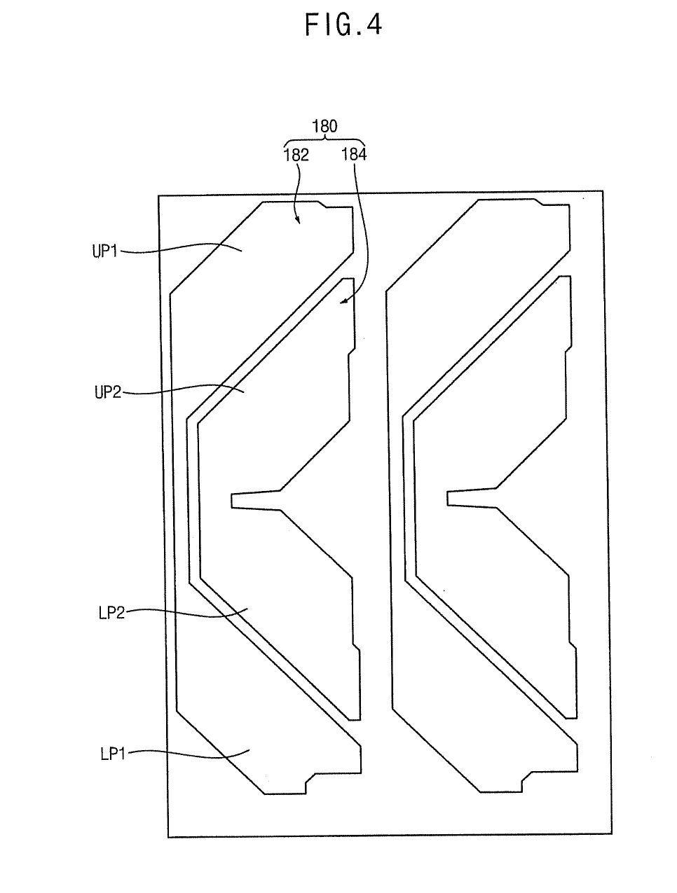

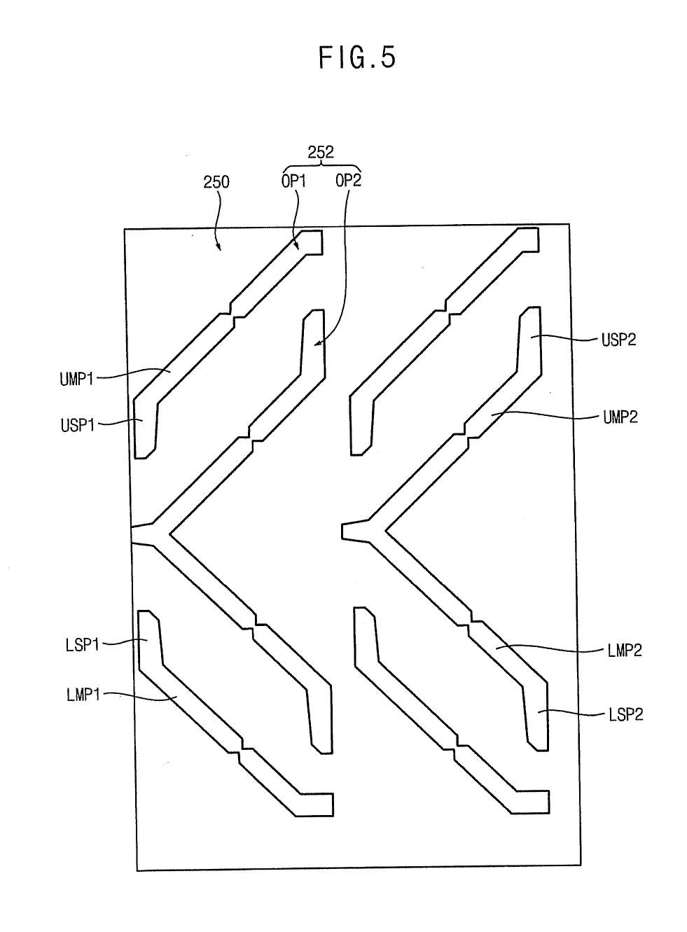

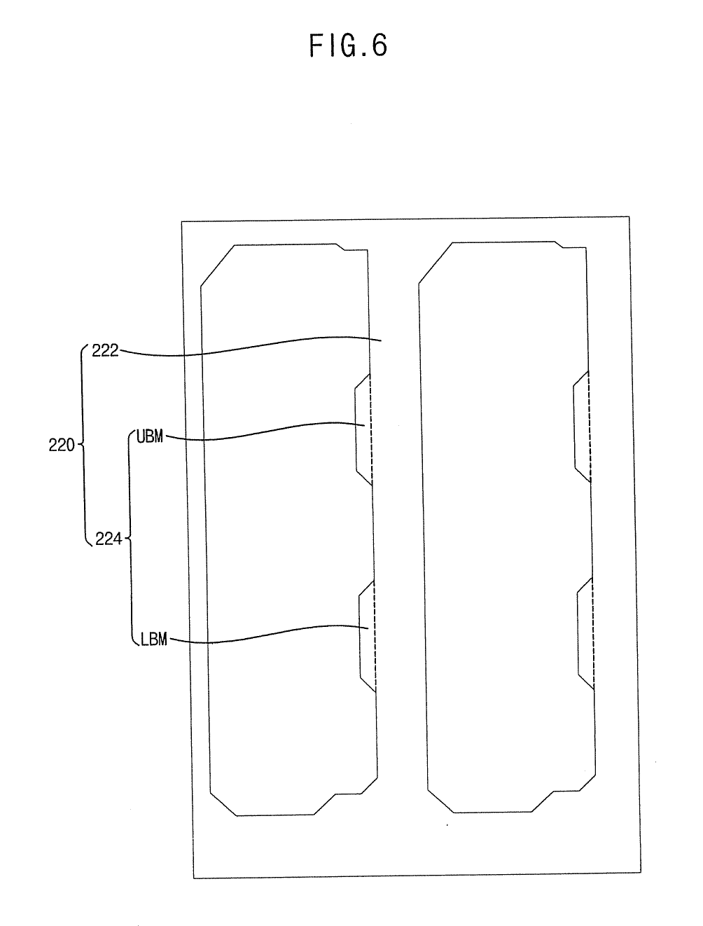

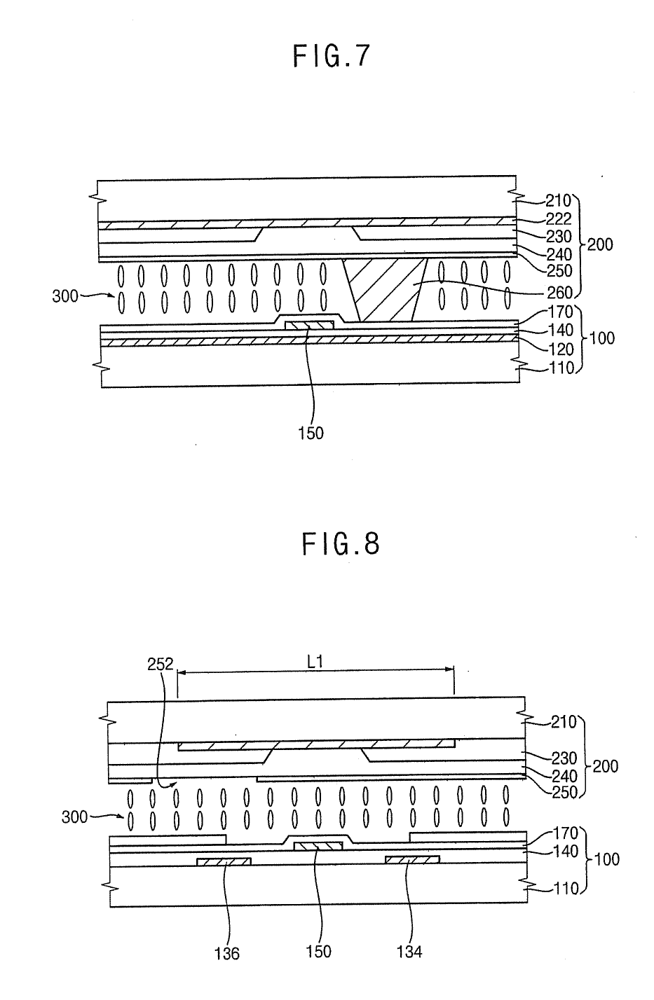

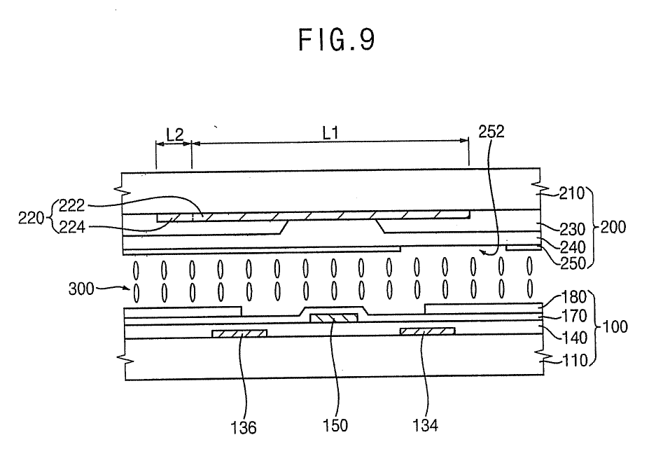

FIG. 1 is a plan view illustrating an exemplary embodiment of a unit pixel of a display panel in accordance with the present invention. FIG. 2 is a plan view illustrating an exemplary embodiment of a storage wiring, a gate wiring and a gate electrode of the unit pixel of FIG. 1. FIG. 3 is a plan view illustrating an exemplary embodiment of a data wiring, a source electrode, a drain electrode, a connecting electrode and an active layer of the unit pixel of FIG. 1. FIG. 4 is a plan view illustrating an exemplary embodiment of a pixel electrode of the unit pixel of FIG. 1. FIG. 5 is a plan view illustrating an exemplary embodiment of a common electrode of the unit pixel of FIG. 1. FIG. 6 is a plan view illustrating an exemplary embodiment of a light-blocking layer of the unit pixel of FIG. 1. FIG. 7 is a cross-sectional view taken along line I-I′ of FIG. 1. FIG. 8 is a cross-sectional view taken along line II-II′ of FIG. 1. FIG. 9 is a cross-sectional view taken along line III-III′ of FIG. 1.

Referring to FIGS. 1 to 9, a display panel includes a first substrate 100, a second substrate 200 and a liquid crystal layer 300.

The first substrate 100 includes a plurality of pixel electrodes disposed substantially in a matrix arrangement, a plurality of thin film transistors and a plurality of signal lines. Each of the thin film transistors applies a driving voltage to each of the pixel electrodes. Each of the signal lines drives each of the thin film transistors.

The second substrate 200 faces the first substrate 100. The second substrate 200 is disposed at a front surface of the display panel. The second substrate includes a common electrode having a transparent conductive material and color filters facing the pixel electrodes. In exemplary embodiments, the color filters may include a red color filter, a green color filter, a blue color filter and so on.

The liquid crystal layer 300 is disposed between the first substrate 100 and the second substrate 200. An orientation of the liquid crystal layer 300 is rearranged by an electric field formed between the pixel electrode and the common electrode. The rearranged liquid crystal layer 300 adjusts a light-transmittance rate of incident light, and light adjusted by the light-transmittance rate passes through the color filters, such that images are displayed.

Referring to FIGS. 1 to 4, 7 to 9, the first substrate 100 includes a first transparent substrate 110, a gate wiring 120, a storage wiring 130, a gate insulation layer 140, a data wiring 150, a thin film transistor 160, a first connecting electrode CE1, a second connecting electrode CE2, a protective layer 170 and a pixel electrode 180.

The first transparent substrate 110 is formed as a substantial plate shape and includes a transparent material. In one exemplary embodiment, the first transparent substrate 100 may include, but is not limited to, glass, quartz, sapphire or a transparent synthetic resin.

Referring to FIGS. 1 and 2, a plurality of the gate wirings 120 is formed on the first transparent substrate 110 in a first direction, and a plurality of storage wirings 130 is formed on the first transparent substrate 110 in the first direction. A more detailed explanation concerning the storage wiring 130 will be discussed later.

The gate insulation layer 140 is formed on the first transparent substrate 110 to cover the gate wirings 120 and the storage wiring 130. In one exemplary embodiment, the gate insulation layer 140 may include, but is not limited to, silicon nitride (SiNx) or silicon oxide (SiOx).

Referring to FIGS. 1 and 3, a plurality of the data wirings 150 are formed on the gate insulation layer 140 in a second direction which is substantially perpendicular to the first direction. The gate wirings 120 are extended in the first direction different from the second direction of the data wirings 150. In an exemplary embodiment, a plurality of unit pixels having a substantially rectangular shape may be defined by intersections of the gate wirings 120 and the data wirings 150. In an exemplary embodiment, each of the unit pixels may be formed as a rectangular shape, and a longitudinal direction of the rectangular shape is substantially parallel with the second direction.

Referring to FIGS. 1 to 3, the thin film transistor 160 includes a gate electrode G, an active layer A, a source electrode S and a drain electrode D. The thin film transistor of the first embodiment is formed at a first side with respect to the data wiring 150.

The gate electrode G is a portion of the gate wiring 120 formed at the first side with respect to the data wiring 150. The active layer A is formed on the gate insulation layer 140 corresponding to the gate electrode G. The source electrode S is extended from the data wiring 150 in a direction of a first side (e.g., left in FIG. 3) with respect to the data wiring 150, and is overlapped with a portion of the active layer A. In one exemplary embodiment, the source electrode S may be formed as a substantial L-shape. The drain electrode D is extended in the second direction, is separated from the source electrode S at a predetermined distance, and is overlapped with a portion of the active layer A.

Referring to FIG. 3, the first connecting electrode CE1 and the second connecting electrode CE2 are formed on the gate insulation layer 140, and are formed in each of the unit pixels. The first connecting electrode CE1 and the second connecting electrode CE2 are electrically connected to the drain electrode D of the thin film transistor 160, respectively.

The protective layer 170 is formed on the gate insulation 140 to cover the data wiring 150, the thin film transistor 160, the first connecting electrode CE1 and the second connecting electrode CE2. In an exemplary embodiment, the protective layer 170 may include silicon nitride (SiNx) or silicon oxide (SiOx). A contact hole 172 is formed at an area of the protective layer 170 corresponding to the first connecting electrode CE1.

Referring to FIGS. 1 and 4, the pixel electrode 180 is formed on the protective layer 170, and is formed in each of the unit pixels. The pixel electrode 180 includes a transparent conductive material. In one exemplary embodiment, the pixel electrode 180 may include indium tin oxide (ITO), indium zinc oxide (IZO), amorphous indium tin oxide (a-ITO) and so on. The pixel electrode 180 includes a first pixel part 182 and a second pixel part 184 electrically separated from each other.

The first pixel part 182 surrounds an outline of the second pixel part 184 and has a profile corresponding to a profile of the second pixel part 184. The second pixel part 184 is formed at a central part in each of the unit pixels (e.g., in the second direction as illustrated in FIG. 4). The first pixel part 182 is formed at an upper part and a lower part in each of the unit pixels (e.g., in the second direction) to surround an outline of the second pixel part 184. The first pixel part 182 and the second pixel part 184 may be formed as a substantially symmetrical structure with respect to a virtual central line crossing a center of each of the unit pixels in the first direction.

The first pixel part 182 includes a first upper pixel UP1 formed at an upper part of the unit pixel with respect to the virtual central line, and a first lower pixel LP1 formed at a lower part of the unit pixel with respect to the virtual central line and electrically connected to the first upper pixel UP1.

The second pixel part 184 includes a second upper pixel UP2 formed at an upper part of the unit pixel with respect to the virtual central line, and a second lower pixel LP2 formed at a lower part of the unit pixel with respect to the virtual central line and electrically connected to the second upper pixel UP2.

The first upper pixel UP1 and the second upper pixel UP2 are separated from each other at a predetermined distance and formed longitudinally in a third direction, such as at an incline of about 45 degrees with respect to the first direction. The first lower pixel LP1 and the second lower pixel LP2 are separated from each other at a predetermined distance and formed longitudinally in a fourth direction, such as a direction substantially perpendicular to the third direction.

The first pixel part 182 is electrically connected to the first connecting electrode CE1 through the contact hole 172 formed in the protective layer 170. The first lower pixel LP1 of the first pixel part 182 is electrically connected to the first connecting electrode CE1.

The second pixel part 184 is separated from the second connecting electrode CE2 at a predetermined distance (e.g., taken perpendicular to the plan view of FIGS. 3 and 4) by the protective layer 170 to form a voltage reducing capacitor. The second connecting electrode CE2 is formed in an area corresponding to a center of the second pixel part 184 to overlap the second pixel part 184.

The first pixel part 182 is electrically connected to the first connecting electrode CE1, and receives a first driving voltage from the drain electrode D of the thin film transistor 160. The second connecting electrode CE2 directly receives the first driving voltage from the drain electrode D, and the second pixel part 184 indirectly receives a second driving voltage from the second connecting electrode CE2. The second driving electrode is at a lower level than the first driving voltage due to the voltage reducing capacitor.

Referring to FIGS. 1 and 2, the storage wiring 130 includes a main storage part 132, a first sub storage part 134 and a second sub storage part 136.

The main storage part 132 is formed in the first direction and substantially parallel with the gate wiring 120. The main storage part 132 crosses the data wiring 150. The main storage part 132 may be formed at an upper part of each of the unit pixels, which is considered a lower part of the gate wiring 120.

The first sub storage part 134 is extended from the main storage part 132 in the second direction, and is overlapped with a portion of the pixel electrode 180. The first sub storage part 134 is separated from a right side of an adjacent of the data wiring 150 at a predetermined distance, and is formed substantially in parallel with the data wiring 150.

The second sub storage part 136 is extended from the main storage part 132 in the second direction, and is overlapped with an end portion of the pixel electrode 180 (e.g., on the rightmost side of the pixel electrode 180 as illustrated in FIG. 4). The second sub storage part 136 is separated from a left side of an adjacent of the data wiring 150, and is formed substantially in parallel with the data wiring 150.

The first sub storage part 134 is formed at the right side, and the second sub storage part 126 is formed at the left side with respect to the data wiring 150.

Referring to FIGS. 1, 5 and 6 to 9, the second substrate includes a second transparent substrate 210, a light-blocking layer 220, a color filter 230, a planarization layer 240, a common electrode 250 and a cell gap sustaining member 260.

The second transparent substrate 210 is formed in a substantially plate shape, and includes a transparent material. The second transparent substrate 210 faces the first transparent substrate 110.

The light-blocking layer 220 is formed on the second transparent substrate 210, and blocks light. More detailed explanation concerning the light-blocking layer 220 will be discussed later.

The color filter 230 is formed on the second transparent substrate 210 to cover the light-blocking layer 220. The color filter 230 is formed in an area corresponding to the pixel electrode 180 in each unit pixel. In one exemplary embodiment, the color filter 230 may include, but is not limited to, a red color filter, a green color filter and a blue color filter. As used herein “corresponding” indicates corresponding substantially in shape, dimension and/or positional placement.

The planarization layer 240 covers the color filter 230 and the light-blocking layer 220, and planarizes a surface of the second substrate 200. In one exemplary embodiment, the planarization layer 240 may include an organic insulation layer.

The common electrode 250 is formed on the planarization layer 240. The common electrode 250 includes a transparent conductive material. In one exemplary embodiment, the common electrode 250 may include indium tin oxide (ITO), indium zinc oxide (IZO), amorphous indium tin oxide (a-ITO) and so on. An domain defining member 252 is formed in an area corresponding to the pixel electrode 180, and divides each of the unit pixels into a plurality of domains.

Referring to FIG. 5, the domain defining member 252 includes a first open part OP1 formed in an area corresponding to the first pixel part 182 and a second open part OP2 formed in an area corresponding to the second pixel part 184. The first open part OP1 and the second open part OP2 may be formed as a substantially symmetric structure with respect to a central line of each of the unit pixels taken in the first direction.

The first open part OP1 includes a first upper domain defining part UMP1 formed in the third direction and corresponding to the first upper pixel UP1 (FIG. 4), and a first lower domain defining part LMP1 formed in the fourth direction and corresponding to the first lower pixel LP1 (FIG. 4).

Moreover, the first open part OP1 may further include a first upper branch USP1 and a first lower branch LSP1. The first upper branch USP1 is electrically connected to an end portion of the first upper domain defining part UMP1, and covers a part of an end portion of the first upper pixel UP1 adjacent to the data wiring 150. The first lower branch LSP1 is electrically connected to an end portion of the first lower domain defining part LMP1, and covers a part of an end portion of the first lower pixel LP1 adjacent to the data wiring 150.

The first upper branch USP1 is downwardly extended (e.g., in the second direction) from the end portion of the first upper domain defining part UMP1, substantially parallel with the data wiring 150, and covers an end portion of the first upper pixel UP1. The first lower branch LSP1 is upwardly (e.g., in the second direction) extended from the end portion of the first lower domain defining part LMP1, substantially parallel with the data wiring 150, and covers an end portion of the first lower pixel LP1.

The second open part OP2 includes a second upper domain defining part UMP2 formed in the third direction and corresponding to the second upper pixel UP2, and a second lower domain defining part LMP2 formed in fourth direction and corresponding to the second lower pixel LP2. In one exemplary embodiment, the second upper domain defining part UMP2 and the second lower domain defining part LMP2 are electrically connected to each other.

Moreover, the second open part OP2 may further include a second upper branch USP2 and a second lower branch LSP2. The second upper branch USP2 is electrically connected to an end portion of the second upper domain defining part UMP2, and covers a part of an end portion of the second upper pixel UP2 adjacent to the data wiring 150. The second lower branch LSP2 is electrically connected to an end portion of the second lower domain defining part LMP2, and covers a part of an end portion of the second lower pixel LP2 adjacent to the data wiring 150.

The second upper branch USP2 is upwardly extended (e.g., in the second direction) from the end portion of the second upper domain defining part UMP2, substantially parallel with the data wiring 150, and covers an end portion of the second upper pixel UP2. The second lower branch LSP2 is downwardly extended from the end portion of the second lower domain defining part LMP2, substantially parallel with the data wiring 150, and covers an end portion of the second lower pixel LP2.

Referring to FIGS. 1 and 7, the cell gap sustaining member 260 is formed on the common electrode 250, and makes contact with the first substrate 100 to sustain a cell gap between the first and second substrates 100 and 200. The cell gap sustaining member 260 may include an organic material. In one exemplary embodiment, the cell gap sustaining member 260 may be formed by patterning, such as through a photo process.

The cell gap sustaining member 260 is formed at a first side with respect to the data wiring 150. The thin film transistor 160 is formed at a second side opposite to the first side with respect to the data wiring 150. As in the illustrated embodiment, the cell gap sustaining member 260 may be formed at a right side and the thin film transistor 160 is formed at a left side, respectively, with respect to the data wiring 150.

Referring to FIGS. 1, 6, 8 and 9, the light-blocking layer 220 includes a main light-blocking part 222 and a sub light-blocking part 224. In an exemplary embodiment, the light-blocking layer 220 may include an organic material or an inorganic material blocking light.

The main light-blocking 222 is formed along edges of the unit pixel, and covers the gate wiring 120, the data wiring 150 and the thin film transistor 160. A width L1 in the first direction of a part of the main light-blocking part 222 which covers the data wiring 150 may be between about 2 microns (μm) to about 25 microns (μm).

The sub light-blocking part 224 is protruded from the main light-blocking part 222 to an area in which the domain defining member 252 is not formed. For example, the sub light-blocking part 224 may be protruded toward a central line of the unit pixel, and may be adjacent to the domain defining member 252. When the cell gap sustaining member 260 is formed at a first side with respect to the data wiring 150, the sub light-blocking part 224 may be formed at the second side opposite to the first side with respect to the data wiring 150. As in the illustrated embodiment of FIG. 1, the cell gap sustaining member 260 of the first embodiment may be formed at a right side with respect to the data wiring 150, and the sub light-blocking part 224 is protruded from the main light-blocking part 222 to left, e.g., on a left side with respect to the date wiring 150. A protruding length L2 of the sub light-blocking part 224 in the first direction may be between about 1 μm to about 2 μm.

Referring to FIG. 6, the sub light-blocking part 224 includes an upper sub light-blocking layer UBM and a lower sub light-blocking layer LBM. The upper sub light-blocking layer UBM is protruded at one end portion of the second upper pixel UP2 where the second upper branch USP2 is not formed. Moreover, the lower sub light-blocking layer LBM is protruded at a portion where the second lower branch LSP2 is not formed.

As in the illustrated embodiment, the sub light-blocking part 224 includes two extended portions from the main light-blocking part 222 and protrudes at substantially the same distance from the main light-blocking part 222, but the present invention is not limited thereto. The sub light-blocking part 224 may include more or less than two extended portions and/or the distance of protrusion of the sub light-blocking part may be equal or different at positions along the main light-blocking part 222 in the second direction. The sub light-blocking parts 224 may be disposed substantially in a same arrangement and/or position in the second direction along the edge of the main light-blocking part 222, but the invention is not limited thereto. Alternatively, the sub light-blocking part 224 of unit pixels, such as adjacent unit pixels, may be staggered or alternated in their positions in the second direction.

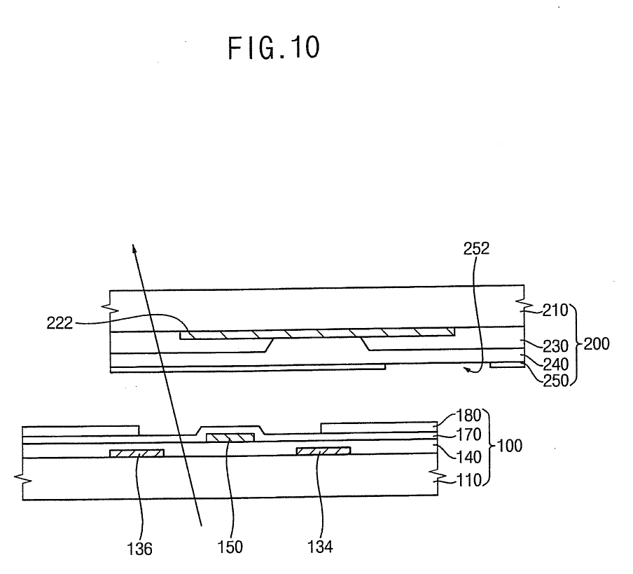

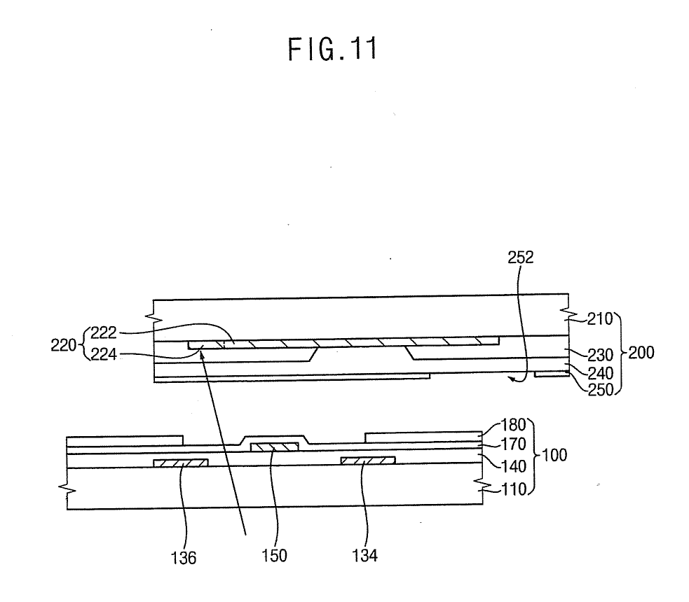

FIG. 10 is a cross-sectional view illustrating an exemplary embodiment of a misalignment of the first and second substrates of FIG. 9 omitting the sub light-blocking layer 224. FIG. 11 is a cross-sectional view illustrating a misalignment of the first and second substrates of FIG. 9.

Referring to FIGS. 10 and 11, an effect of the illustrated embodiment will be discussed. The light-blocking layer illustrated in FIG. 10 includes a main light-blocking part 222, and the light-blocking layer 220 illustrated in FIG. 11 includes the main light-blocking part 222 and a sub light-blocking part 224.

The first and second substrates 100 and 200 may be misaligned by an external impact. As in the illustrated embodiment, the cell gap sustaining member 260 is formed at the right side with respect to the data wiring 150. When the external impact is applied to the first and second substrates 100 and 200, the second substrate 200 is misaligned to the right with respect to the first substrate 100. A surface of the first substrate 100 includes a protruded area or surface created by the data wiring 150, such that the second substrate 200 having the cell gap sustaining member 260 may not move to the left when the external impact is applied. The gap sustaining member 260 is blocked or restricted from moving to the left by the protruded surface and, as a result, moves to the right. Therefore, as illustrated in FIGS. 10 and 11, the second substrate 200 is misaligned to the right with respect to the first substrate 100 by the external impact.

When the light-blocking layer 220 includes the main light-blocking part 222 as illustrated in FIG. 10 and the second substrate 200 is misaligned to the right with respect to the first substrate 100, light generated under the first substrate 100 and entering a space between the data wiring 150 and the second sub storage part 136 (e.g., when viewed in a plan view) may not be blocked by the main light-blocking part 222. This unblocked light (as indicated by the arrow in FIG. 10) may ultimately emit outside and a light-leaking phenomenon occurs. In an exemplary embodiment, when the light entering the space between the data wiring 150 and the second sub storage part 136 passes through an area of an end portion of the pixel electrode 180 that is not covered by the domain defining member 252 of the common electrode 250, the light-leaking phenomenon occurs more frequently and to a larger degree.

However, when the light-blocking layer 220 includes not only the main light-blocking part 222 but also the sub light-blocking part 224 as illustrated in FIG. 11, even though the second substrate 200 is misaligned to the right with respect to the first substrate 100, the light entering the space between the data wiring 150 and the second sub storage part 136 may be blocked by the sub light-blocking part 224 as indicated by the arrow. In an exemplary embodiment and in order to reduce or effectively prevent a decrease of brightness, the sub light-blocking part 224 may be protruded from the main light-blocking part 222 to a region in which the domain defining member 252 of the common electrode 250 is not formed, and the sub light-blocking part 224 may block the light entering the space between the data wiring 150 and the second sub storage part 136. In exemplary embodiments, the sub light-blocking part 224 is extended from the main light-blocking part 222 in a direction opposite to a side of the data wiring where the cell gap sustaining member 260 may be formed to essentially compensate for the shifting distance of the first and second substrates 100 and 200 relative to each other and to block light transmitted between the data wiring 150 and the second sub storage part 136.

As in the illustrated embodiment, the sub light-blocking part 224 is protruded to the region in which the domain defining member 252 of the common electrode 250 is not formed to reduce or effectively prevent the light-leaking phenomenon, such that image display quality improves.

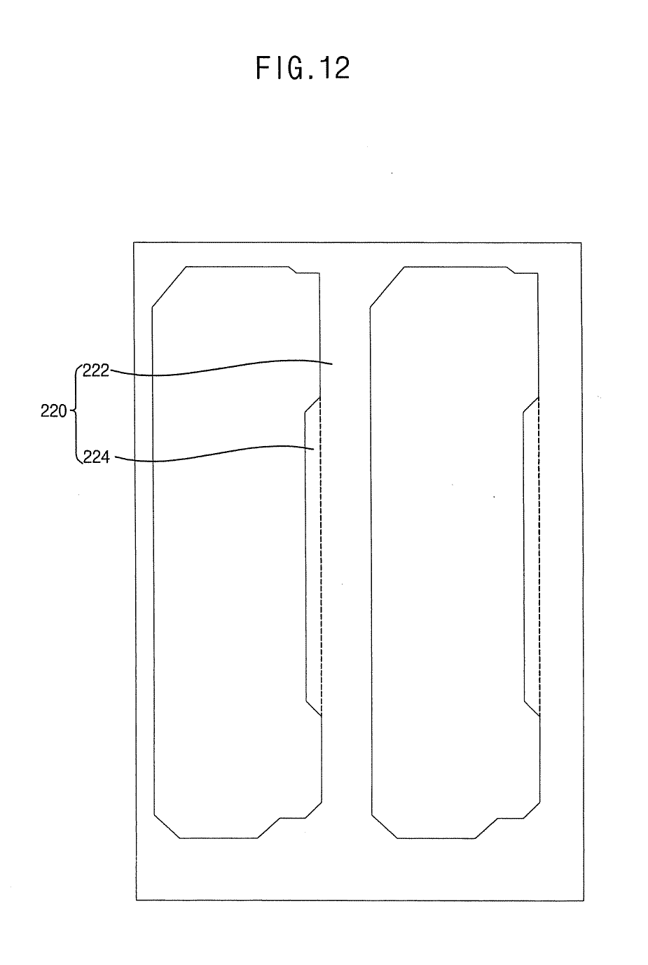

FIG. 12 is a plan view illustrating another exemplary embodiment of a light-blocking layer of a unit pixel of a display panel in accordance with the present invention. The display panel FIG. 12 is substantially the same as the display panel of FIGS. 1-11 except for a light-blocking layer. Thus, the same reference numerals will be used to refer to the same or like parts as those described in FIGS. 1-11 and any further repetitive explanation concerning the above elements will be omitted.

Referring to FIG. 12, a light-blocking layer 220 includes a main light-blocking part 222 and a sub light-blocking part 224.

The main light-blocking part 222 is formed along edges of each of the unit pixels and covers a gate wiring 120, a data wiring 150 and a thin film transistor 160. A width of a portion of the main light-blocking part 222 covering the data wiring 150 may be between about 21 μm to about 25 μm.

The sub light-blocking part 224 is protruded from the main light-blocking part 222 to a region in which the domain defining member 252 is not formed. In one exemplary embodiment, the sub light-blocking part 224 may be protruded toward a central line of the unit pixel, and may be adjacent to the domain defining member 252. When the cell gap sustaining member 260 is formed at a first side with respect to the data wiring 150, the sub light-blocking part 224 may be protruded from the main light-blocking part 222 to a second side opposite to the first side with respect to the data wiring 150.

In one exemplary embodiment, the cell gap sustaining member 260 of FIG. 12 is formed at the right side with respect to the data wiring 150, and the sub light-blocking part 224 is protruded from the main light-blocking part 222 to a left side. The sub light-blocking part 224 may be protruded from the main light-blocking part 222 to the left side at a length of about 1 μm to 2 μm.

The sub light-blocking part 224 of FIG. 12 is protruded from the main light-blocking part 222 to an area in which the second open part OP2 of the common electrode 250 is not formed. The sub light-blocking part 224 covers an area of an end portion of the second upper pixel UP2 of the pixel electrode 180 in which the second upper branch USP2 of the common electrode 250 is not formed, an area of an end portion of the second lower pixel LP2 of the pixel electrode 180 in which the second lower branch LSP2 of the common electrode 150 is not formed and an end portion of an area between the second upper pixel UP2 and the lower pixel LP2. The sub light-blocking part 224 is formed in the second direction substantially parallel with the data wiring 150 between the upper branch USP2 and the second lower branch LSP2 of the common electrode 250.

As in the illustrated embodiment, the sub light-blocking part 224 is a single extended portion from the main light-blocking part 222. The distance the sub light-blocking part 224 protrudes from the main light-blocking part 222 is substantially the same along the second direction, but the present invention is not limited thereto.

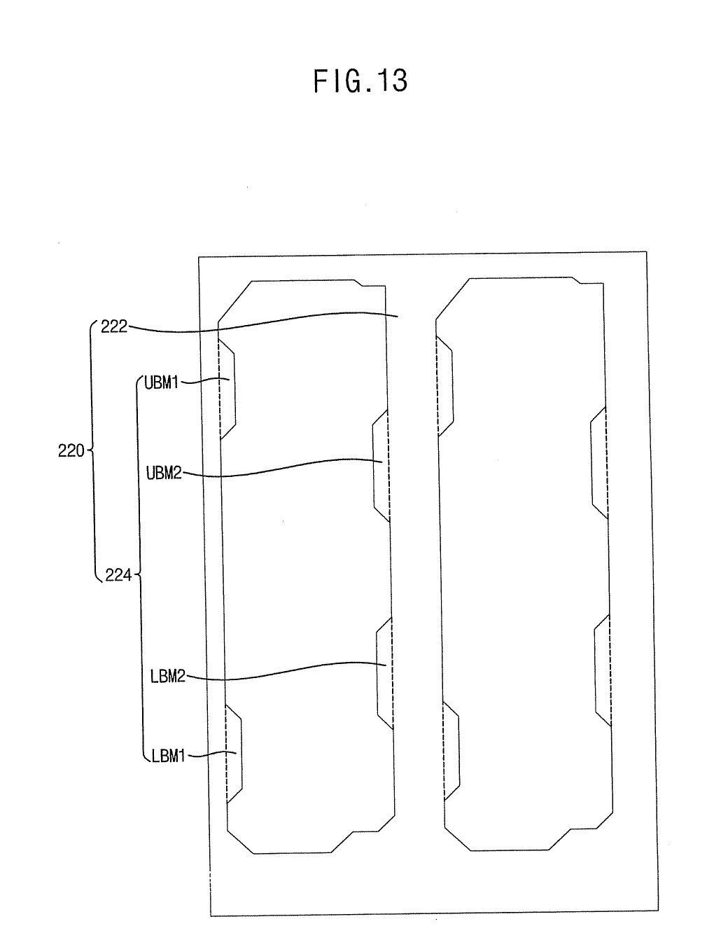

FIG. 13 is a plan view illustrating another exemplary embodiment of a light-blocking layer of a unit pixel of a display panel in accordance with the present invention. The display panel of FIG. 13 is substantially the same as the display panel in FIGS. 1-11 except for a light-blocking layer. Thus, the same reference numerals will be used to refer to the same or like parts as those described in FIGS. 1-11 and any further repetitive explanation concerning the above elements will be omitted.

Referring to FIG. 13, a light-blocking layer 220 includes a main light-blocking part 222 and a sub light-blocking part 224.

The main light-blocking part 222 is formed along edges of each of the unit pixels to cover a gate wiring 120, a data wiring 150 and a thin film transistor 160. A width in the first direction of a portion of the main light-blocking part 222 covering the data wiring 150 may be between about 21 μm to about 25 μm.

The sub light-blocking part 224 is protruded from the main light-blocking part 222 to an area in which the domain defining member 252 is not formed. The sub light-blocking part 224 may be protruded from the main light-blocking part 222 to a left side at a length of about 1 μm to 2 μm.

The sub light-blocking part 224 includes a first upper sub light-blocking layer UBM1, a first lower sub light-blocking layer LBM1, a second upper sub light-blocking layer UBM2 and a second lower sub light-blocking layer LBM2.

The first upper sub light-blocking UBM1 is protruded to an end portion of the first upper pixel UP1 of the pixel electrode 180 in which the first upper branch USP1 of the common electrode 250 is not formed. The first upper sub light-blocking UBM1 is protruded at a right side with respect to the data wiring 150 to cover a portion of an end portion of the first upper pixel UP1 of the pixel electrode 180.

The first lower sub light-blocking LBM1 is protruded to an end portion of the first lower pixel LP1 of the pixel electrode 180 in which the first lower branch LSP1 of the common electrode 250 is not formed. The first lower sub light-blocking LBM1 is protruded at a right side with respect to the data wiring 150 to cover a portion of an end portion of the first lower pixel LP1 of the pixel electrode 180.

The second upper sub light-blocking UBM2 is protruded to an end portion of the second upper pixel UP2 of the pixel electrode 180 in which the second upper branch USP2 of the common electrode 250 is not formed. The second upper sub light-blocking UBM2 is protruded at a left side with respect to the data wiring 150 to cover a portion of an end portion of the second upper pixel UP2 of the pixel electrode 180.

The second lower sub light-blocking LBM2 is protruded to an end portion of the second lower pixel LP2 of the in which the second lower sub opening LSP2 is not formed. The second lower sub light-blocking LBM2 is protruded at a right side with respect to the data wiring 150 to cover a part of an end portion of the second lower pixel LP2 of the pixel electrode 180.

In an exemplary embodiment the second upper light-blocking layer UBM2 and the second lower sub light-blocking layer LBM2 may be electrically connected to each other and formed integrally. As used herein, “integrally” is used to indicate formed to be a single unit or part rather than combining or including multiple discrete elements.

When a display panel receives an external impact, the second substrate 200 may move to the right with respect to the first substrate 100, or may move to the left. When the cell gap sustaining member 260 is not formed at left or right side with respect to the data wiring 150 but formed at a center between the adjacent data wirings 150 to each other, the second substrate 200 may be misaligned to the left or right side with respect to the first substrate 100.

In the illustrated embodiment, the first upper sub light-blocking layer UBM1 and the first lower sub light-blocking layer LBM1 are formed at the right side with respect to the main light-blocking layer 222 so that light leakage caused by the movement of the second substrate 200 at the left side with respect to the first substrate 100 is reduced or effectively prevented. Moreover, the second upper sub light-blocking layer UBM2 and the second lower sub light-blocking layer LBM2 are formed at the left side with respect to the main light-blocking layer 222 so that light leaking that is caused by the movement of the second substrate 200 at the right side with respect to the second substrate 100 is reduced or effectively prevented. Advantageously, when the sub light-blocking layers are extended in a direction opposite to the movement of the second substrate 200 relative to the first substrate 100, a light leakage that may be caused by the movement is reduced or effectively prevented.

In the illustrated embodiment, the first and second upper sub light blocking layers UBM1 and UBM2 are staggered in arrangement relative to each other along the second direction of the main light blocking layer 222. Portions of the first and second upper sub light blocking layers UBM1 and UBM2 overlap with each other in a first direction. The first and second lower sub light blocking layers LBM1 and LBM2 are staggered in arrangement relative to each other along the second direction of the main light blocking layer 222. Portions of first and second lower sub light blocking layers LBM1 and LBM2 overlap with each other in a first direction. Alternatively, the first and/or the second sub light-blocking layers may be configured as a single (e.g., integral) element.

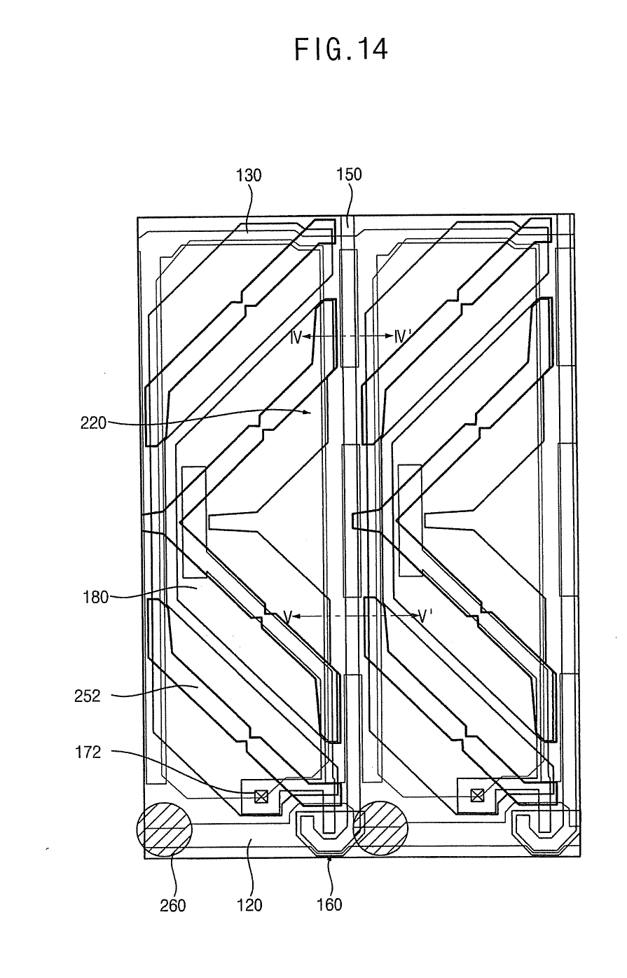

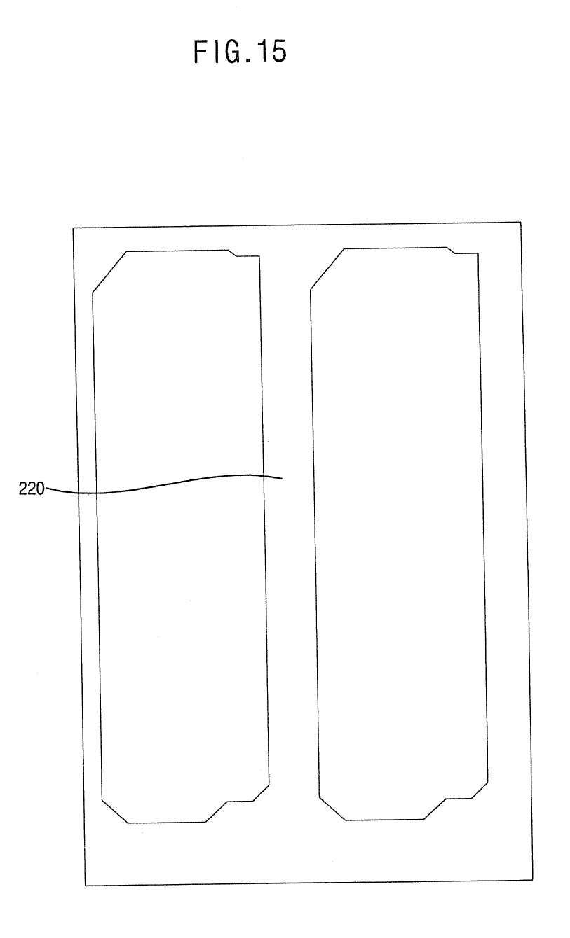

FIG. 14 is a plan view illustrating another exemplary embodiment of a unit pixel of the display panel in accordance with the present invention. The display panel of FIG. 14 is substantially the same as the display panel of FIGS. 1-11 except for a light-blocking layer and a storage wiring. Thus, the same reference numerals will be used to refer to the same or like parts as those described in FIGS. 1-11 and any further repetitive explanation concerning the above elements will be omitted. FIG. 15 is a plan view illustrating an exemplary embodiment of a light-blocking layer in the unit pixel of FIG. 14.

Referring to FIGS. 14 and 15, a light-blocking layer 220 is formed along edges of each of the unit pixels to cover the gate wiring 120, the data wiring 150 and the thin film transistor 160. In an exemplary embodiment, the light-blocking layer 220 may be further extended to an area in which the domain defining member 252 is not formed.

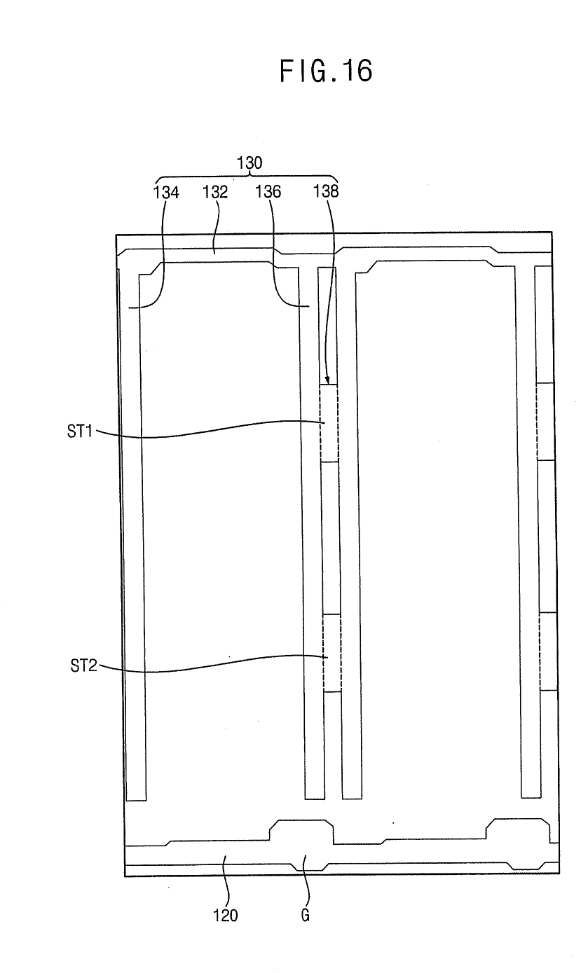

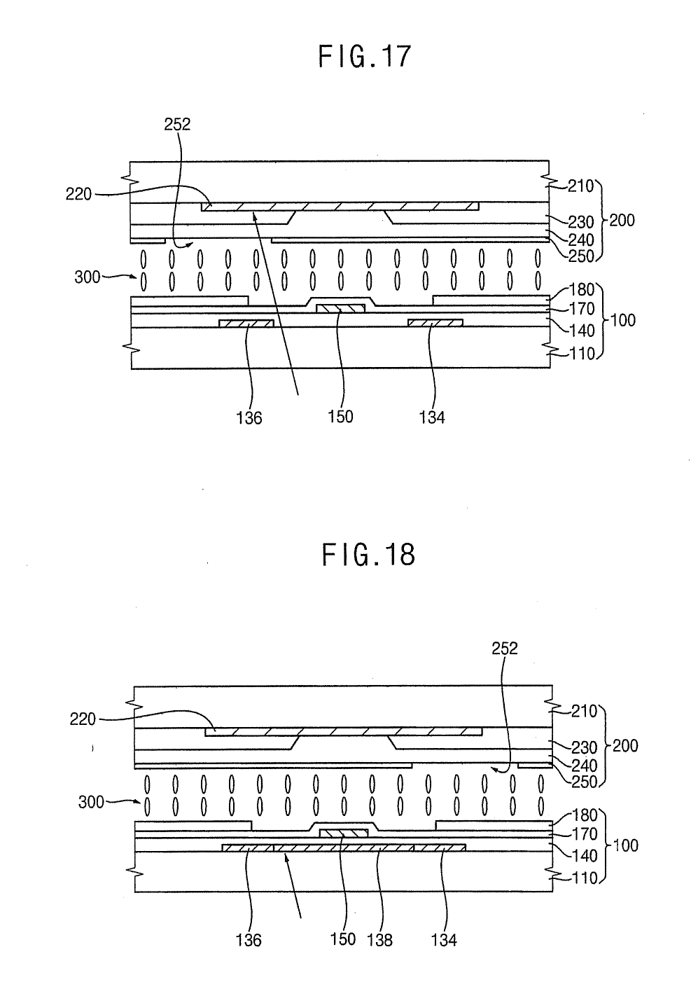

FIG. 16 is a plan view illustrating an exemplary embodiment of a storage wiring of the unit pixel of FIG. 14. FIG. 17 is a cross-sectional view taken along line IV-IV′ of FIG. 14. FIG. 18 is a cross-sectional view taken along line V-V′ of FIG. 14.

Referring to FIGS. 14 and 16 to 18, the storage wiring 130 includes a main storage part 132, a first sub storage part 134, a second sub storage part 136 and a light-blocking storage part 138.

The main storage part 132 is formed at an upper portion of each of the unit pixels, i.e., under the gate wiring 120 such as taken in a plan view.

The first sub storage part 134 is extended from the main storage part 132 in the second direction, and is overlapped with an end portion of the pixel electrode 180. The first sub storage part 134 is separated from an adjacent of the data wiring 150 to a right side, and is formed substantially parallel with the data wiring 150.

The second sub storage part 136 is extended from the main storage part 132 in the second direction, and is overlapped with a portion of the pixel electrode 180 (e.g., on the rightmost side of the pixel electrode 180). The second sub storage part 136 is separated from an adjacent of the data wiring 150 to a left side, and is formed substantially parallel with the data wiring 150.

The first sub storage part 134 is formed at the right side, and the second sub storage part 136 is formed at the left side, respectively, with respect to the data wiring 150.

The light-blocking storage part 138 electrically connects the first sub storage part 134 to the second sub storage part 136 The light-blocking storage part 138 is partially overlapped with a portion of the data wiring 150 (e.g., when viewed in a plan view). The first sub storage part 134 and the second sub storage part 136 are disposed at opposing sides with respect to the data wiring 150, respectively. The light-blocking storage part 138 faces the data wiring 150 (e.g., taken perpendicular to the plan view of FIGS. 14-16) and corresponding to an area in which the domain defining member 252 of the common electrode 250 is not formed.

Referring to FIG. 16, the light-blocking storage part 138 includes a first light-blocking electrode ST1 and a second light-blocking electrode ST2. The first light-blocking electrode ST1 is formed in an end portion of the second upper pixel UP2 of the pixel electrode 180 corresponding to an area in which the second upper domain defining part UMP2 of the common electrode 250 is not formed. The second light-blocking electrode ST2 is formed in an end portion of the second lower pixel LP2 of the pixel electrode 180 corresponding to an area in which the second lower domain defining part LMP2 of the common electrode 250 is not formed.

As in the illustrated embodiment, the light-blocking storage part 138 is overlapped with a portion of the data wiring 150 to block light (e.g., indicated by the arrow in FIG. 18), so that light leaking caused by a misalignment of the first and second substrates 100 and 200 is reduced or effectively prevented. The light-blocking storage part 138 essentially covers or fills the space (e.g., when viewed in a plan view) between the data wiring 150 and the first or second storage part 134 or 136, respectively.

When the light-blocking storage part 138 is not disposed between the first and second sub storage parts 134 and 136, light generated under a first substrate 100 may enter a space between a data wiring 150 and a first sub storage part 134 or between the data wiring 150 and a second sub storage part 136. As a result, light may be leaked due to a misalignment between the first substrate 100 and a second substrate 200, such as misalignment caused by an external impact.

However, as in the illustrated embodiment, light entering the space between the data wiring 150 and the first sub storage part 134 or between the data wiring 150 and the second sub storage part 136 is essentially completely blocked by the light-blocking storage part 138, such that light leaking caused by misalignment of the first substrate 100 and second substrate 200 is reduced or effectively prevented.

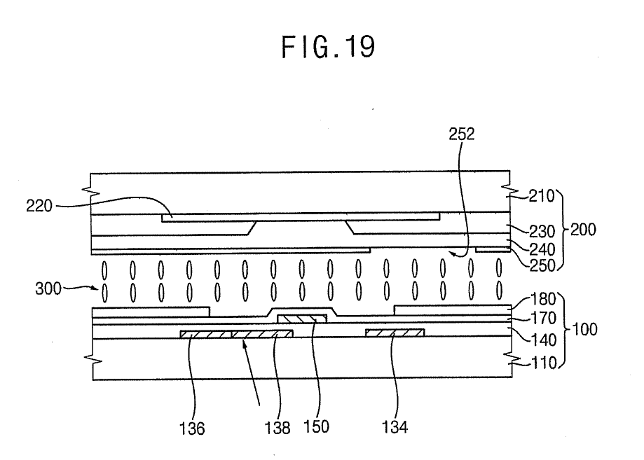

FIG. 19 is a cross-sectional view illustrating an exemplary embodiment of a portion of a unit pixel of a display panel in accordance with the present invention. The display panel of FIG. 19 is substantially the same as the display panel in FIGS. 14-18 except for a light-blocking layer of a storage wiring. Thus, the same reference numerals will be used to refer to the same of like parts as those described in FIGS. 14-18 and any further repetitive explanation concerning the above elements will be omitted.

Referring to FIG. 19, a light-blocking storage part 138 is extended from one of the first and second storage parts 134 and 136 to the data wiring 150, and is overlapped with a portion of the data wiring 150, such as without facing an entire of the data wiring 150. Alternatively, the light-blocking storage part 138 may be extended from one of the first or the second storage parts 134 and 136, face an entire of the data wiring 150 and/or extend into the gap between the data wiring 150 and the other of the first or the second storage parts 134 and 136.

In an exemplary embodiment, when the cell gap sustaining member 260 is formed at a first side with respect to the data wiring 150, the light-blocking storage part 138 may be extended to the first side with respect to the data wiring 150 and may be overlapped with a portion of the data wiring 150.

In one exemplary embodiment, when the cell gap sustaining member 260 is formed at a right side with respect to the data wiring 150, the light-blocking storage part 138 may be extended to the right side from the second sub storage part 136 and may be overlapped with a portion of the data wiring 150.

Alternatively, when the cell gap sustaining member 260 is formed at a left side with respect to the data wiring 150, the light-blocking storage part 138 may be extended to the left side from the second sub storage part 136 and may be overlapped with a portion of the data wiring 150.

The light-blocking part 138 faces the data wiring 150 and corresponds to an area in which the domain defining member 252 of the common electrode 250 is not formed. In an exemplary embodiment, the light-blocking storage part 138 may include a first light-blocking electrode and/or a second light-blocking electrode. The first light-blocking electrode may be formed in an end portion of the second upper pixel UP2 of the pixel electrode 180 corresponding to an area in which the second upper domain defining part UMP2 of the common electrode 250 is not formed. The second light-blocking electrode may be formed in an end portion of the second lower pixel LP2 of the pixel electrode 180 corresponding to an area in which the second lower domain defining part LMP2 of the common electrode is not formed.

As in the illustrated embodiment, the light-blocking storage part 138 is overlapped with a portion of the data wiring 150 and blocks light entering a space between the first sub storage part 134 and/or between the data wiring 150 and the second sub storage part 136, such that light leaking caused by misalignment of the first and second substrates 100 and 200 is reduced or effectively prevented.

In an exemplary embodiment, an area of the light-blocking part 138 overlapping with the data wiring 150 may be minimized, such that transmission characteristics of a data signal of the data wiring 150 by the light-blocking part 138 improves.

As in the illustrated embodiments, a sub light-blocking part is protruded from a main light-blocking part to an area in which a domain defining member of a common electrode is not formed, and a light-blocking storage part is extended from first and second sub storage parts to correspond to an area in which the domain defining member of the common electrode is not formed and is overlapped with a portion of the data wiring, such that light leaking, such as a result of misalignment of first and second substrates, is reduced or effectively prevented and image display quality improves.

By now, those of some skills in this art will appreciate that many modifications, substitutions and variations can be made in and to the materials, apparatus, configurations and methods of the display panels of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A display panel comprising:
a first substrate including;
a gate wiring formed in a first direction;
a data wiring formed in a second direction substantially perpendicular to the first direction;
a thin film transistor electrically connected to the gate wiring and the data wiring; and
a pixel electrode electrically connected to the thin film transistor and formed in a unit pixel;
a second substrate including;
a common electrode disposed on the second substrate, corresponding to the pixel electrode;
a domain defining member dividing the unit pixel into a plurality of domains, the domain defining member having a portion paralleling to the data wiring; and
a light-blocking layer including a main light-blocking part disposed at edges of the unit pixel and covering the gate wiring and the data wiring, and a sub light-blocking part extended from the main light-blocking part, wherein the sub light-blocking part is protruded toward an area in which the domain defining member paralleling to the data wiring is not disposed; and
a liquid crystal layer disposed between the first substrate and the second substrate.

2. The display panel of claim 1, wherein the second substrate further comprises a cell gap sustaining member sustaining a cell gap between the first and second substrates and disposed at a first side with respect to the data wiring.

3. The display panel of claim 2, wherein the thin film transistor is disposed at a second side opposite to the first side with respect to the data wiring.

4. The display panel of claim 2, wherein the sub light-blocking part is protruded from the main light-blocking part at a length in the first direction of between about 1 micron (μm) and about 2 microns (μm).

5. The display panel of claim 4, wherein a width in the first direction of the main light-blocking part covering the data wiring is between about 21 μm and about 25 μm.

6. The display panel of claim 1, wherein the domain defining member comprises:
a body inclined with respect to the first direction; and
a branch connected to an end portion of the body extended in the second direction.

7. The display panel of claim 1, wherein the pixel electrode comprises a first pixel part and a second pixel part electrically separated from each other, and
the domain defining member comprises a first domain defining part disposed in an area corresponding to the first pixel part and a second domain defining part disposed in an area corresponding to the second pixel part.

8. The display panel of claim 7, wherein the first pixel part is configured to surround the second pixel part, and
the first and second pixel parts are disposed substantially symmetric with respect to a virtual central line crossing a center of the unit pixel in the first direction.

9. The display panel of claim 8, wherein the first pixel part comprises a first upper pixel disposed at an upper side of the first pixel part with respect to the virtual central line, and a first lower pixel disposed at a lower side of the first pixel part with respect to the virtual central line of the unit pixel and electrically connected to the first upper pixel, and
the second pixel part comprises a second upper pixel disposed at an upper side of the second pixel part with respect to the virtual central line of the unit pixel and a second lower pixel disposed at a lower side of the second pixel part with respect to the virtual central line of the unit pixel.

10. The display panel of claim 9, wherein the first and second upper pixels are extended in a third direction inclined at about 45 degrees with respect to the first direction, and
the first and second lower pixels are extended in a fourth direction substantially perpendicular to the third direction.

11. The display panel of claim 10, wherein the first domain defining part of the common electrode comprises a first upper domain defining part extended in the third direction and corresponding to the first upper pixel and a first lower domain defining part extended in the fourth direction and corresponding to the first lower pixel, and
the second domain defining part of the common electrode comprises a second upper domain defining part extended in the third direction and corresponding to the second upper pixel and a second lower domain defining part extended in the fourth direction and corresponding to the second lower pixel.

12. The display panel of claim 11, wherein the first domain defining part of the common electrode further comprises:
a first upper branch connected to an end portion of the first upper domain defining part and covering a portion of an end portion of the first upper pixel of the pixel electrode facing the data wiring; and
a first lower branch connected to an end portion of the first lower domain defining part and covering a portion of an end portion of the first lower pixel of the pixel electrode facing the data wiring.

13. The display panel of claim 12, wherein the sub light-blocking part of the light-blocking layer comprises:
a first upper sub light-blocking layer protruded toward an end portion of the first upper pixel of the pixel electrode where the first upper branch of the common electrode is not disposed; and
a first lower sub light-blocking layer protruded toward an end portion of the first lower pixel of the pixel electrode where the first lower branch of the common electrode is not disposed.

14. The display panel of claim 11, wherein the second domain defining part of the common electrode further comprises:
a second upper branch connected to an end portion of the second upper domain defining part and covering a portion of an end portion of the second upper pixel of the pixel electrode facing the wiring data; and
a second lower branch connected to an end portion of the second lower domain defining part and covering a portion of an end portion of the second lower pixel of the pixel electrode facing the wiring data.

15. The display panel of claim 14, wherein the sub light-blocking part of the light-blocking layer comprises:
a second upper sub light-blocking layer protruded toward an end portion of the second upper pixel of the pixel electrode where the second upper branch of the common electrode is not disposed; and
a second lower sub light-blocking layer protruded toward an end portion of the second lower pixel of the pixel electrode where the second lower branch of the common electrode is not disposed.

16. The display panel of claim 1, wherein the first substrate further includes a storage wiring partially overlapped with the pixel electrode, and
the storage wiring comprises:
a main storage part parallel to the gate wiring;
a first sub storage part overlapped with a first end portion of the pixel electrode; and
a second sub storage part overlapped with a second end portion to the first end portion of the pixel electrode.

17. The display panel of claim 16, wherein the storage wiring further comprises a connecting storage part connecting the first sub storage part to the second sub storage part disposed at opposing sides of the data wiring.

18. The display panel of claim 17, wherein the connecting storage part corresponds to an area where the domain defining member parallel to the data wiring is not disposed.

19. A display panel comprising:
a first substrate including;
a gate wiring formed in a first direction;
a data wiring formed in a second direction which is substantially perpendicular to the first direction;
a thin film transistor electrically connected to the gate wiring and the data wiring;
a pixel electrode electrically connected to the thin film transistor; and
a storage wiring overlapped with the pixel electrode and a portion of the data wiring;
a second substrate including;
a light-blocking layer; and
a common electrode corresponding to the pixel electrode, and
a domain defining member dividing a plurality of domains, the domain definging member being adjacent to the storage wiring; and
a liquid crystal layer disposed between the first substrate and the second substrate.

20. The display panel of claim 19, wherein the storage wiring comprises:
a main storage part extended in the first direction;
a first sub storage part extended from the main storage part in the second direction overlapped with a first end portion of the pixel electrode;
a second sub storage part extended from the main storage part in the second direction overlapped with a second end portion to the first end portion of the pixel electrode; and
a connecting storage part connecting the first sub storage part to the second sub storage part disposed at opposing sides of the data wiring and overlapped with a portion of the data wiring.

21. The display panel of claim 20, wherein the second substrate further includes a cell gap sustaining member sustaining a cell gap between the first and second substrates and disposed at a first side with respect to the data wiring, and
the light-blocking storage part is extended toward the first side with respect to the data wiring.

22. The display panel of claim 20, wherein the domain defining member comprises a bodyinclined with respect to the first direction and a branch connected to the body and extended in the second direcction, and
the sub light-blocking part of the light-blocking layer is protruded toward an area in which the branch is not disposed.
